(19) United States
(12) Patent Application Publication
(10) Pub. No.: US 2006/0198640 A1
(43) Pub. Date: Sep. 7, 2006

(54) Method and apparatus for PMD mitigation in optical communication systems

(76) Inventors: Robert Meachem Jopson, Rumson, NJ (US); Herwig Werner Kogelnik, Rumson, NJ (US); Peter J. Winzer, Aberdeen, NJ (US)

Correspondence Address: Lucent Technologies Inc.;Docket Administrator - Room 3J-219, 101 Crawfords Corner Road, Holmdel, NJ, 07733-3030, US

(21) Appl. No.: 11/073,061

(22) Filed: Mar. 4, 2005

(51) Int. Cl. H04B 10/00

(52) U.S. Cl. 398/152

(57) ABSTRACT

An optical communication system is provided comprising a transmission link including one or more quasi-static waveguide sections coupled by one or more non-static coupling sections. A transmitter is coupled to the transmission link and is adapted to transmit optical signals through the transmission link with wavelength channel spacing of the optical signals greater than about the PMD correlation bandwidth of at least one of the one or more quasi-static waveguide sections, such that the PMD induced outage probability for the system is optimized.

### FIELD OF THE INVENTION

The present invention relates to optical communications, and more specifically to methods and apparatus for polarization-mode-dispersion (PMD) mitigation in optical communication systems.

### BACKGROUND OF THE INVENTION

Deviations from the nominal circular symmetry of optical fiber lead to birefringence, resulting in different group velocities for orthogonal polarization modes. Two polarization components of an optical signal thus experience some differential group delay (DGD), which may also change with wavelength. Since optical receivers typically detect the total optical power, irrespective of polarization, DGD manifests itself in pulse spreading, called polarization-mode dispersion (PMD). For a DGD of ˜10% of the bit rate of an optical signal (the exact number depending on modulation format and receiver properties), pulses start to significantly spread energy into neighboring bit slots, and bit errors occur. Time-varying stress exerted on the fiber (e.g., mechanical vibrations, temperature variations) randomly changes the DGD; typical rates of change range from milliseconds (acoustic vibrations) to months (buried fiber).

PMD-induced signal distortions vary randomly in time, and may lead to error bursts disrupting communication. By the very nature of PMD, the amount of signal distortions can be exceedingly large, yet with a very low probability of occurrence. Therefore, systems may occasionally fail, even if high link budget margins are allocated to combat PMD. Knowing about this stochastic behavior of PMD, one therefore allocates a certain margin to accommodate most instances of PMD-induced signal distortions, and intentionally leaves the system vulnerable to random instances of PMD exceeding this margin. The system's robustness to PMD is then quantified by an outage probability, defined as the probability of PMD-induced error bursts not accommodated for by the allocated margin.

Using traditional models, outage probabilities could be well calculated by specifying the deterministic PMD tolerance of a transmitter-receiver pair, and then invoking Maxwellian statistics for the differential group delay (DGD). In the frame of this traditional model, these statistics apply over time as well as across channels in a wavelength-division multiplexed (WDM) system, and are used to compute and specify system outage probabilities. However, recent studies on the PMD characteristics of a deployed fiber plant show that typical transmission links consist of several (5 to 10) stable long fiber sections well sheltered from the environment over extended periods of time (i.e., months) (referred to as quasi-static waveguide sections or stable fiber sections). On these time scales the PMD characteristics of these sections are not impacted by temperature variations or mechanical vibrations. The stable fiber sections are connected by pieces of environmentally unprotected fiber such as dispersion compensating modules at repeater sites, or fiber patchcords in switching offices (referred to as non-static coupling sections or “hinges”). The polarization characteristics of the hinges vary rapidly in time. A “Hinge Model” has been proposed to characterize the PMD statistics of such fiber links. The DGD of the long and stable sections still has a Maxwellian probability density (PDF) in the wavelength dimension, but is essentially frozen in time. However, the overall PDF of the link DGD now becomes non-Maxwellian. In particular, the DGD at any given wavelength has an upper bound, and each wavelength band (comprising one or more channels) has a different outage probability. Most importantly, some wavelength bands (or channels) will comply with a prescribed outage specification while others will not. Thus, compared to traditional PMD outage statistics, where all WDM channels show identical, easy-to-specify outage probabilities, we have an additional parameter: the fraction of the WDM fiber spectrum that is noncompliant with a given outage specification, which we call the noncompliant capacity ratio (NCR).

Within the confines of the hinge model, the DGD values of each section are fixed in time but are different for each statistically independent wavelength band (bands may contain one or more WDM channels and are considered statistically independent when their spectral separation exceeds 6 times the bandwidth of the PSP of a section. The bandwidth of the PSP (Δν_{PSP}) is given by:
Δν_{PSP}=125 GHz/Mean DGD of a section [ps]. (1)

One may compute the NCR as a function of the Specified Outage Probability (as shown in Attachment 1 appended hereto). The traditional model is shown as the square curve: All WDM channels have an outage probability of 10⁻⁴ for the assumed mean DGD of 5 ps and a 40-Gb/s return-to-zero (RZ) communication system. Using the hinge model, the other curve shows that a substantial fraction of fiber capacity will have a significantly higher outage probability than 10⁻⁴ and will therefore violate the outage specification of 10⁻⁴.

### SUMMARY OF THE INVENTION

The present invention provides methods and apparatus for multi-channel PMD/PDL/PDG mitigation.

According to one embodiment, the present invention an optical communication system is provided comprising a transmission link including one or more quasi-static waveguide sections coupled by one or more non-static coupling sections. A transmitter is coupled to the transmission link and is adapted to transmit optical signals through the transmission link with wavelength channel spacing of the optical signals greater than about the PMD correlation bandwidth of at least one of the one or more quasi-static waveguide sections, such that the PMD induced outage probability for the system is optimized.

### DETAILED DESCRIPTION OF THE INVENTION

In one aspect of the present invention methods and apparatus are employed to take advantage of this statistical theory discussed above. For example, can over-provision a WDM system by an amount NCR, and, on average, still strictly satisfy a desired outage specification. Alternatively, one has to accept different outage probabilities on different channels. This thinking works if WDM channels are statistically independent. Therefore, and from the perspective of NCR only, one needs to make sure that when deploying the system, one populates WDM channels sufficiently far apart such that these channels are uncorrelated, with Eq. (1) being the measure for statistical independence. Table 1 in the Attachment gives an example for how far WDM channels should be spaced apart.

Additionally, if a system uses PMD compensation, one can take advantage of the fact that PMD is correlated over a certain wavelength band, and one can therefore compensate a whole band of channels simultaneously, where the extent of the band would also be given by Table 1. In this case, channels are preferably installed in bands, such that one fills up a band first. After filling up a band, one should install another band that is not immediately adjacent to the first installed band in order to avoid adverse PMD correlation.

Although the invention has been described with reference to illustrative embodiments, this description should not be construed in a limiting sense. Various modifications of the described embodiments, as well as other embodiments of the invention, which are apparent to persons skilled in the art to which the invention pertains, are deemed to lie within the principle and scope of the invention as expressed in the following claims.

We claim:

1. An optical communication system comprising:
transmission links including one or more quasi-static waveguide sections coupled by one or more non-static coupling sections;
a transmitter adapted to transmit optical signals through the transmission links with wavelength channel spacing of the optical signals greater than about the PMD correlation bandwidth of at least one of the one or more quasi-static waveguide sections, such that the PMD induced outage probability for the system is optimized.

2. A method of transmitting an optical signal in a system having a transmission link with one or more quasi-static waveguide sections coupled by one or more non-static coupling sections, the method comprising:
transmitting multichannel optical signals through the transmission link, the multichannel optical signals having a wavelength channel spacing greater than about the PMD correlation bandwidth of at least one of the one or more quasi-static waveguide sections, such that the PMD induced outage probability for the system is optimized.
